(19) United States
(12) Patent Application Publication
(10) Pub. No.: US 2008/0316368 A1
(43) Pub. Date: Dec. 25, 2008

(54) Method and Device For Moving a Camera Disposed on a Pan/Tilt Head Long a Given Trajectory

(75) Inventors: Uwe Fritsch, Grobenzell (DE); Walter Honegger, Sonthofen (DE)

Correspondence Address: WOOD, HERRON & EVANS, LLP, 2700 CAREW TOWER, 441 VINE STREET, CINCINNATI, OH, 45202, US

(73) Assignees: KUKA ROBOTER GMBH, Augsburg (DE); CINE-TV BROADCAST SYSTEMS GMBH, Grobenzell (DE)

(21) Appl. No.: 12/096,228

(22) PCT Filed: Dec. 7, 2006
(86) PCT No.: PCT/EP2006/011752

§ 371 Date: Aug. 5, 2008

(30) Foreign Application Priority Data
Dec. 9, 2005 (DE) 10 2005 058 867.0

(51) Int. Cl. H04N 5/222; B65B 35/50

(52) U.S. Cl. 348/722; 414/222.02; 348/E05.022; 901/14

(57) ABSTRACT

The invention relates to a method for moving a camera that is disposed on a pan/tilt head along a given trajectory especially in a set or studio as well as an associated camera robot. In order to be able to move a camera with repeated accuracy along a given trajectory, an associated trajectory is determined for the spatial positions and orientations of a basic reference system of the pan/tilt head from the given trajectory for the camera, and associated control variables for shafts of a robot that can be moved in Cartesian coordinates are generated from the determined trajectory for the basic reference system of the pan/tilt head and are transmitted to the shafts, thus allowing camera movements to be made that are not possible with previously known systems.

The invention relates to a method for moving a camera disposed on a pan/tilt head along a given trajectory, especially on a set or in a studio, as well as to a camera robot having a pan/tilt head designed to hold a camera, which is disposed on a receiving flange of a robot.

The invention can preferably be employed in virtual studios, for example for news, reporting, sports reports, and also for creating commercials and video clips, both in the form of live events and in recorded form. Another area of application is film production and postproduction.

The term virtual studio is used for production environments for audiovisual contributions in which real backdrops and sets are replaced, or at least augmented, by computer-generated images. Portions of the space of the virtual studio are replaced in part by computer-generated, or virtual, images or graphics. At the present time this is done using the chroma key method. Newer methods provide for digital stamping techniques.

The virtual image sources can be for example weather maps, which are added to a blue screen. When using static virtual images, movements of the camera are not allowed. If the camera were to be moved, discrepancies in perspective would result between real and virtual parts of the picture. As a consequence of the discrepancies of perspective, the unified visual impression of an apparently real world is destroyed. This effect occurs especially severely in the case of panning movements of the camera.

Modern computer graphics make it possible to produce two-dimensional and three-dimensional virtualities that can be inserted into an actual recorded image or series of images in synchronization with camera movements. However, that requires the ability to assign the spatial position and the orientation of the camera in space for each image of a sequence, each so-called frame. The position and orientation are also referred to in combination as the pose. The registered values of positions and orientations of the camera in space are also referred to as tracking data. The registered values can be augmented with interpolated values. The movements of the real camera must be simulated in a virtual studio, in order to be able to define the perspective that matches a particular camera pose and to create the virtual images. To do so, the simulation system must be able to detect the poses of the real camera by means of a camera tracking system, and then to simulate them.

For manually guided cameras there are tracking systems that are able to determine the pose of a camera in all six degrees of freedom, for example by means of infrared measuring cameras, and thus allow motion tracking. However, it is nearly impossible with a manually guided camera to repeat exactly a particular trajectory that is prescribed or has already been executed once.

Automatically guided cameras can repeat exactly trajectories that have already been executed once. To that end the camera is placed on a movable stand. WO 93/06690 A1 shows a remotely controllable movable stand that is equipped with a television camera. Defined positions of the television camera are assigned to a plurality of image settings by means of a control system. That requires traveling to the individual positions and storing them.

The object of the invention is to provide a method and a camera robot by which a camera can be moved along a prescribed trajectory with repeating accuracy.

The repeating accuracy should preferably be possible with automatically moved cameras, but also with manually propelled cameras. The method and the camera robot according to the invention can be employed especially advantageously to enable applying computer-generated (offline programmed) virtual trajectories of a virtual camera directly to a real camera in a simulation, without first having to perform learning runs.

The problem according to the invention is solved in a in method conforming to the genre, in that an associated trajectory is determined for the spatial positions and orientations of a basic reference system of the pan/tilt head from the given trajectory for the camera, and associated control variables that can be moved in Cartesian coordinates for shafts of a robot, to whose receiving flange the pan/tilt head is attached, are generated from the determined trajectory for the basic reference system of the pan/tilt head and are transmitted to the shafts.

According to the invention, the pan/tilt head is guided by the robot in Cartesian coordinates along a trajectory. Because of the motion in Cartesian coordinates, the repeating precision of the motion can be maintained especially well.

Preferably, an articulated-arm robot is employed as the robot. The articulated-arm robot has in particular at least four, and advantageously six axes of rotation. Because of the use of an articulated-arm robot, the same camera poses can be achieved with different joint positions of the articulated-arm robot. That makes a camera robot available that can be employed especially flexibly, since it enables camera movements that were not possible previously with known systems.

If a sequence of positions and orientations of a camera to be traversed along a trajectory is known, then motion commands can be generated from the associated position data which control a robot that guides the camera along the desired trajectory. The drive motors to be actuated by a controller, preferably through servo amplifiers, are driven simultaneously, so that the shafts of the robot can be moved simultaneously. Each robot shaft can have its own controller associated with it, and a plurality of controllers for a plurality of robot shafts can be coupled or synchronized via suitable bus systems. It is also possible according to the invention to provide a specific controller for the drive of the robot shafts, and a separate controller for the functions of the camera and the pan/tilt head. The control of the functional unit of camera and pan/tilt head can be connected with the control of the robot axes through suitable bus systems, which preferably ensure coupled or synchronous operation. For example, the virtual trajectories or prescribed trajectories generated in a simulation of a set or studio can be fed directly to the robot in the real studio, so that the latter can guide the camera on the trajectory with repeating accuracy.

Desired speed or acceleration profiles can be assigned to the given trajectories. It is also possible to assign various speed or acceleration profiles to the same given trajectory, and thus to produce various camera movements with differently acting sequences despite the same trajectory in space. The image sequences created then have different dynamics.

To couple the camera and robot, it is essential that a pan/tilt head be provided between camera and receiving flange of the robot. Together with the camera, the pan/tilt head, which may have the roll function in addition to the applicable pan and tilt functions, forms the functional unit which in particular can be actuated separately from the robot. That can result in an independent orientation of the camera according to the known camera guiding methods, in addition to a spatial pose defined by the robot position. It is especially advantageous that camera controllers which are already on the market can continue to be used for the functions such as pan, tilt, roll, zoom, focus and iris. This is achieved by having the motion plan for the robot shafts refer to the basic reference system of the pan/tilt head, and not to the camera itself. The basis reference system is the name for a coordinate system that has a fixed position in a part of the pan/tilt head assigned to the receiving flange. The use of a robot makes it possible to traverse not only trajectories that are impossible with conventional systems such as the known movable stands. Because a robot has many shafts, the same spatial position can be occupied by means of different combinations of shaft positions through multiple positions of the robot. Hence it is also possible to traverse sequences of positions that are not possible with the known systems.

Camera movements that are achievable with the method according to the invention can be employed not only in virtual studios, but also enable camera movements with formerly unachievable repeating accuracy for example in live programs or sports broadcasts. Using the known systems without movable stands, only motions in the vertical direction and pivoting around the vertical direction (panning) are possible. Movable stands are then required for linear motions in the horizontal direction. When a robot according to the invention is used, linear camera movements in a horizontal direction are possible even when the robot is standing still, without need of an expensive movable stand.

In an advantageous embodiment of the invention, the trajectory for the camera or for the basic reference system of the pan/tilt head can also be traversed through manual movement by means of a controller in real time. To that end, either the spatial position of the basic reference system of the pan/tilt head can be set for example by means of a joystick or some other hand-guided operating part, while the camera can be oriented independently according to the known camera guidance systems, or else the spatial position of the camera can be set directly by means of the joystick or the hand-guided operating part.

In another preferred embodiment of the invention, the trajectory for the camera or for the basic reference system of the pan/tilt head is fed in from a simulation system of a virtual set or studio. In a simulation of sets that have already been created virtually, pre-planning is possible and the trajectory of the camera can be calculated within the simulation. This virtually planned trajectory of the camera can be fed to a controller for the robot and executed for example in real time, so that the robot can guide the camera directly on the planned trajectory. For real-time operation, the robot and/or the unit of camera and pan/tilt head are operated with a controller having real-time capability. This planned trajectory can be repeated by the robot as often as desired and with positional accuracy, without deviations in the pose of the camera on the trajectory. Since the robot system according to the invention has no components that are subject to slippage, true-to-path repeatability of the camera travel on the trajectory is possible. Slippage, such as is present for example in movable stands with wheels, cannot occur in a robot according to the invention.

Alternatively, the trajectory for the camera or for the basic reference system of the pan/tilt head can be stored in a controller for the robot as a pre-programmed trajectory model. By storing pre-programmed trajectory models, a user can get along without complicated and cost-intensive simulation programs and manual learning runs. A trajectory model may be for example a pre-programmed 360° pan around a fixed point. Another trajectory model can be for example a linear pass past a fixed point. At the same time, the camera can optionally be focused on a point in space during the pass. Thus users can use trajectories without having to program them themselves.

In an advantageous refinement, a large number of pre-programmed trajectory models are stored in a controller for the robot. A trajectory model to be executed can be activated by the user as needed by selecting it on an operating device coupled with the controller.

The pre-programmed trajectory model can be stored in a memory that is detachable from the controller. This makes it possible to exchange existing trajectory models simply and inexpensively. Trajectory models that are no longer needed can be removed from the controller, so that these model controllers can no longer be activated. In addition, new trajectory models can be added. Specifying fixed, pre-programmed trajectory models increases the reliability of the robot system, since the user is prevented from exercising any influence, and thus erroneously programmed trajectory models, which could represent a risk to safety, cannot even be created.

In applications having a plurality of cameras on a set or in a studio, the controlling variables for shafts of a first robot can be synchronized with controlling variables of at least one second robot by means of a synchronous control. The synchronization can be achieved for example by having a plurality of cameras focused on a common object from different positions, and when the object moves in space and is tracked by means of the first camera, the other cameras keep the object in focus synchronously with the first camera.

Object tracking is possible with the method according to the invention or with one or more robots, including the option of manual changing. For example, an individual robot can execute an automated motion in which the desired target object always remains captured in the image of the camera, and at the same time a person can control or edit the functions of the camera and/or the position of the pan/tilt head manually. When a plurality of robots or robotic cameras are used, a plurality of cameras can be aimed at a common target object, so that the same object is captured by the cameras simultaneously from different perspectives. However, the plurality of cameras can also be actuated in such a way that a target object is passed from one camera to a next camera. That enables automated object tracking over great distances.

In an advantageous way, the control variables for shafts of the at least one robot can be synchronized by means of a synchronous control with control variables for traveling drives of a movable platform on which the robot is mounted.

The movable platform can be an automatically movable traveling stand, or a platform with omnidirectional drive.

In the configuration as an omnidirectional drive, preferably Mecanum wheels are used.

To improve the positioning accuracy, or also to correct slippage, the position of the movable platform in the plane of travel can be calibrated by means of markers of known position.

One or more optical targets attached in the plane of travel of the movable platform can be used as markers. Preferably, a separate target is assigned to each work location for the robot. A work location is understood here as the basic position of the robot base, from which the camera movements are executed within a set or studio.

The position and/or orientation of the camera in space can be determined optionally by means of markers or wirelessly detectable position sensors. GPS sensors can be used for example as wireless position sensors. Along with the position of the robot base, the height position of the camera can also be determined for example by this means. In addition to the position setting by means of the shaft angle positions of the robot, different height positions of the camera can also be moved to by way of the position of an adjustable-height stand.

In a preferred variant of the method according to the invention, the shafts of the robot are provided with different drive types and/or transmission types depending on various application profiles. It can be advantageous, for example in the cases of applications in which especially slow camera excursions are necessary, to use very greatly reduced transmissions that convert a maximum speed of the drive motor to a very low angular speed for the robot shaft in question. Very slow camera excursions mean for example camera movements in space at travel speeds of 0.01 cm/s or angular velocities of 0.01 degrees/s. In other application cases, for example when tracking objects moving at high speeds, preferably less reduced transmissions are used that enable a high angular speed for the robot shaft in question. Such high speed movements mean for example camera movements in space at travel speeds of 2 m/s or angular velocities of 180 degrees/s.

In an application profile for camera movements that require extremely low noise, servo motors can be employed for example. By preference the servo motors are operated through frequency converters at a frequency of over 15 kilohertz. This enables the camera robots according to the invention to be used even for live recordings with sound and live transmissions, without interference from disturbing sounds that could be caused by drives of the camera robot. No disturbing audible sounds are produced by the operation of frequency converters at a frequency of over 15 kilohertz, so that expensive sound insulation of the robot drives can be dispensed with.

In an application profile for camera movements at low speeds and very low noise, preferably harmonic drive transmissions are used, which enable very high rotational speed trans-mission ratios without free play, with low noise propagation.

Associated with the method according to the invention for moving a camera disposed on a pan/tilt head along a given trajectory is a camera robot according to the invention which is equipped with a pan/tilt head designed to hold a camera, which is disposed on a receiving flange of the robot, where the robot is preferably equipped with at least four rotating shafts. In a preferred embodiment the robot has six rotating shafts. That enables the robot to move the camera to the same desired position with the robot in different positions. Hence the camera can be moved to positions that cannot be reached with known camera stands.

To make the camera system flexible, the camera robot can be connected to a controller that is designed to actuate additional positioning drives for at least the panning and tilting functions of the pan/tilt head.

In addition, the controller can be designed to actuate positioning drives for roll, camera, zoom, focus and/or iris.

Additionally, the camera robot can be disposed on a linear or traveling drive that is actuatable by the controller. A linear drive that is known in particular in robotics can be provided, in order to further increase the mobility of the robot system according to the invention. A linear drive of this sort has the advantage that it enables a linear movement without slippage, whereby even large straight-line movements of the camera can be repeated with exact positioning.

In an alternative embodiment of the invention the camera robot can be disposed on a movable platform.

The movable platform is preferably an automatically movable traveling stand, or a platform with omnidirectional drive.

If the drive is designed as an omnidirectional drive, then Mecanum wheels are preferably provided as the drive wheels.

In addition to guiding the camera and actuating the positioning drives for roll, camera, zoom, focus and/or iris, the controller can also be designed to control additional external studio equipment such as video servers and video mixers. The controller can also be designed so that it can be actuated in turn by the external studio equipment. The precision of the camera robot controller enables it to be linked to newsroom systems.

The invention will be explained in greater detail below on the basis of exemplary embodiments.

The figures show the following:

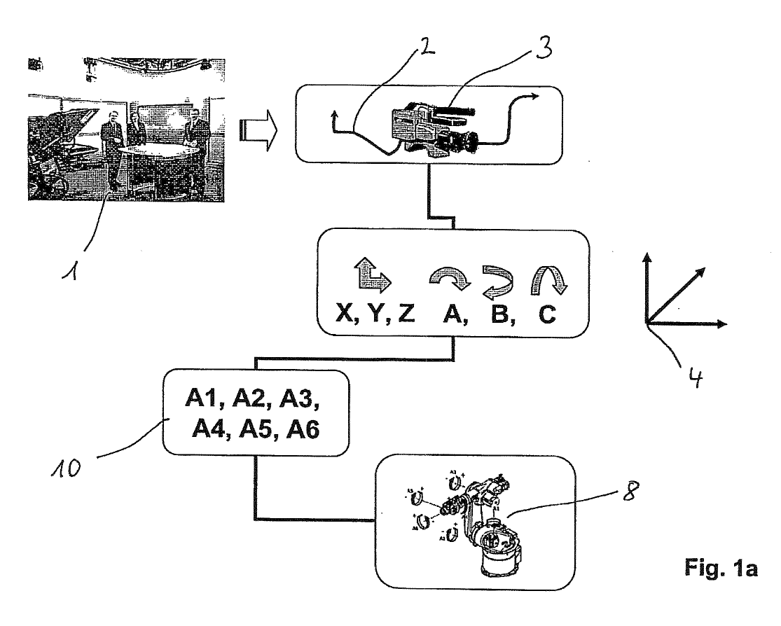

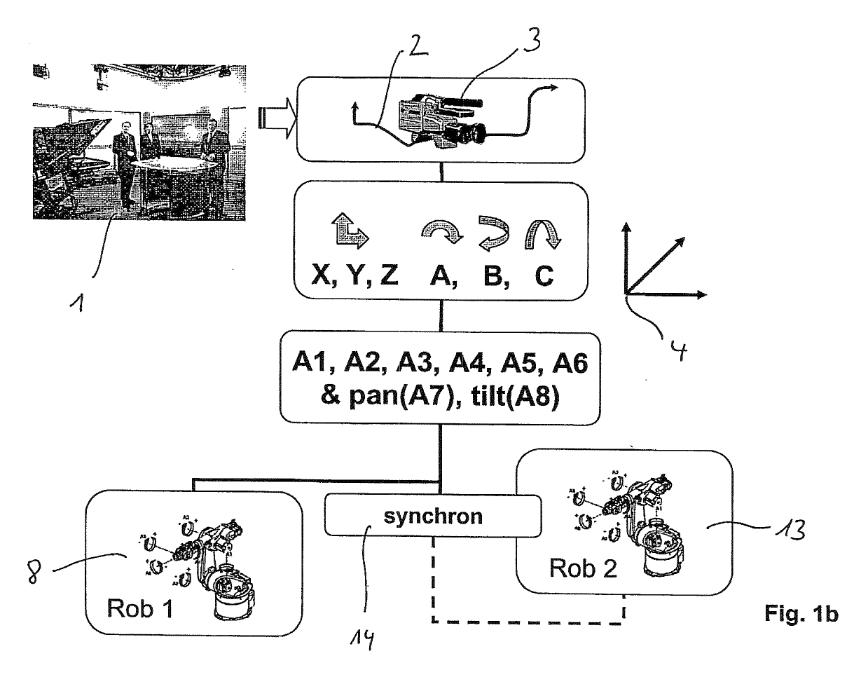

FIG. 1a a schematic depiction of the sequence of a method according to the invention in a basic variant;

FIG. 1b: a schematic depiction of the sequence analogous to FIG. 1a, with the pan and tilt functions as additional axes;

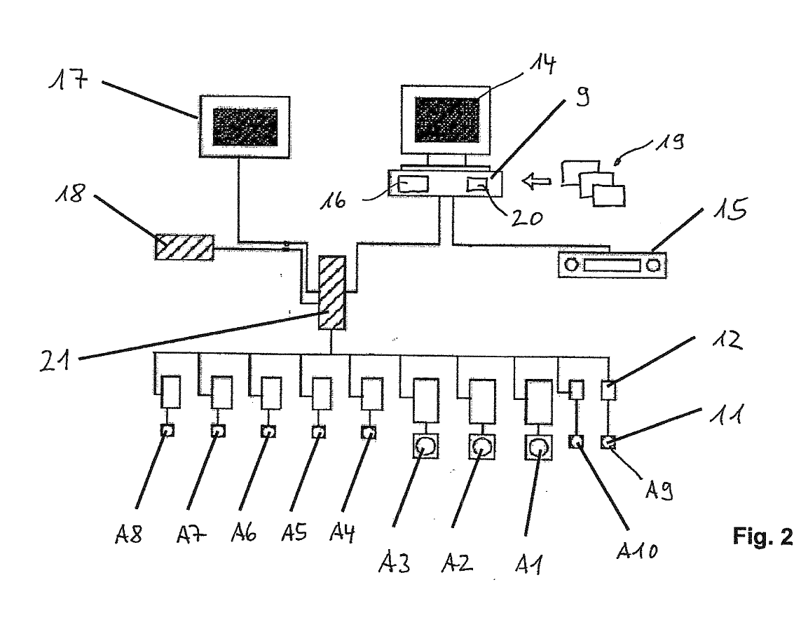

FIG. 2: a schematic depiction of a control system according to the invention;

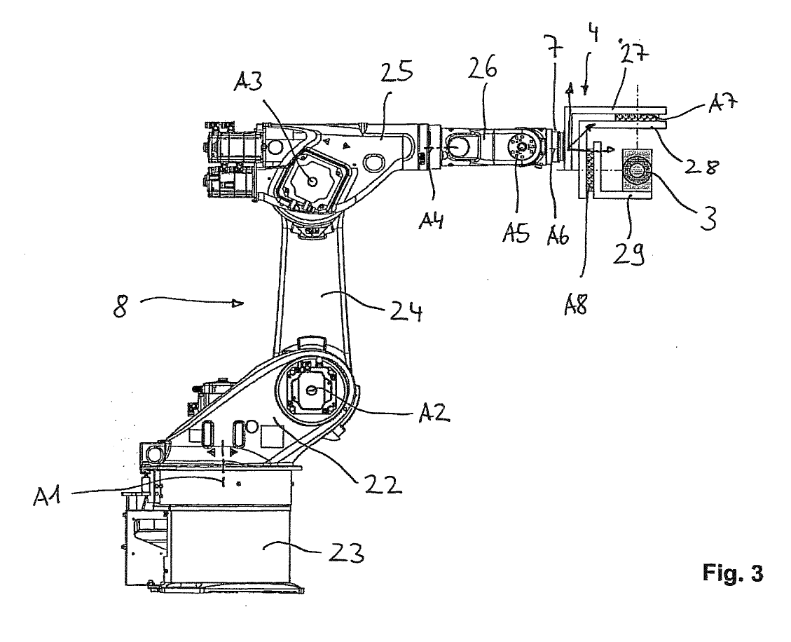

FIG. 3: a side view of a camera robot according to the invention, and

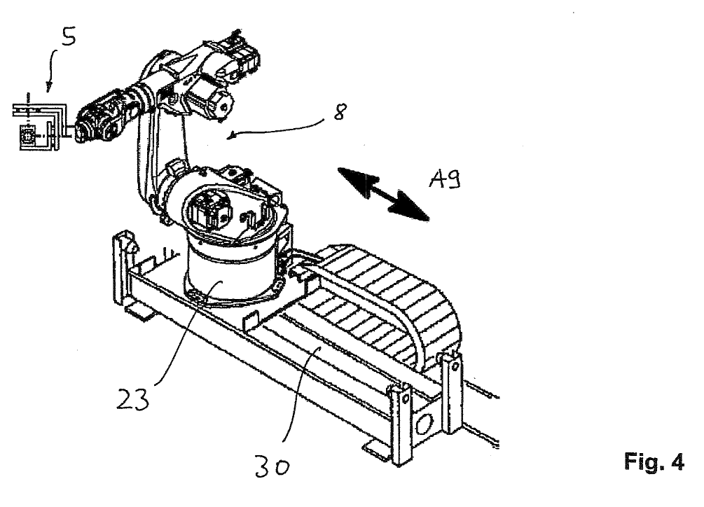

FIG. 4: the camera robot from FIG. 3 with an additional linear axis;

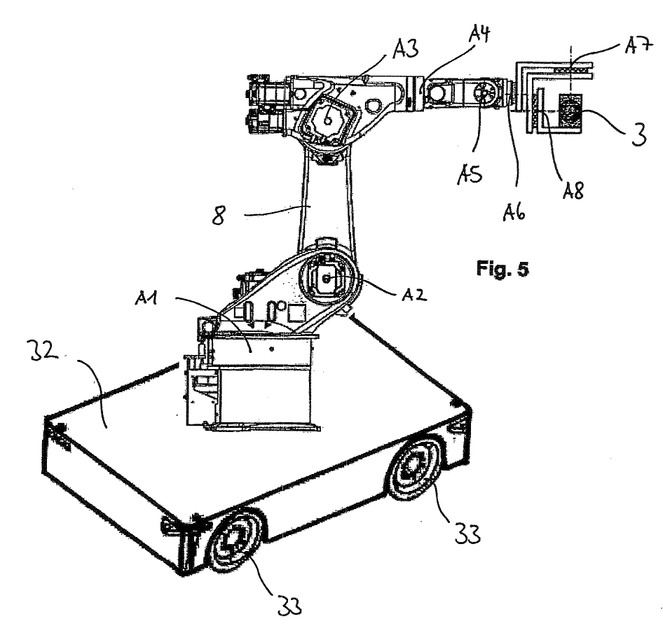

FIG. 5 a camera robot according to the invention with a movable stand.

FIG. 1a depicts schematically the sequence of a method according to the invention. In a TV studio 1 a desired camera movement for a film sequence is planned and a matching trajectory 2 for a camera 3 is defined. The method determines from the defined trajectory 2 for the camera 3 the positions and orientations of a basic reference system 4 in space. As shown in FIG. 2, the basic reference system 4 is located at a firmly defined location of a pan/tilt head 5, to which the camera 3 is attached. The basic reference system 4 is preferably provided on a connecting part 6 of pan/tilt head 5. Connecting part 6 is firmly connected to a receiving flange 7 of a six-shaft industrial robot 8. In this embodiment, basic reference system 4 is coupled in this respect with the motions of receiving flange 7, and thus corresponds to a receiving flange or tool center point (TCP) of the six-shaft industrial robot 8. The positions of basic reference system 4 in space are defined by the three Cartesian spatial coordinates X, Y and Z. The orientations of basic reference system 4 in space are defined by the three rotations in the Cartesian spatial coordinate system. The A rotation preferably corresponds to a rotation around the Z axis, the B rotation to a rotation around the Y axis, and the C rotation to a rotation around the X axis of the Cartesian spatial coordinate system. The trajectory 2 can be re-traversed repeatedly as often as desired by assigning a certain position of basic reference system 4 for example to each time code and working through the time codes in sequence. Normally the time code is tied to the process of the film sequence. From the position and orientation of basic reference system 4, a controller 9 for the six-shaft industrial robot 8 can determine by means of suitable inverse transformation algorithms the requisite angular positions 10 of the robot shafts A1, A2, A3, A4, A5 and A6 to set the particular position and orientation of basic reference system 4. Corresponding control variables for the shaft drives 11 of the six-axis industrial robot 8 are generated from the calculated angular positions 10 by means of associated servo-amplifiers 12, and are transmitted to the shaft drives 11.

FIG. 1b shows an expanded variant, with the pan and tilt functions as additional axes A7 and A8. The trajectory 2 for the camera 3 is determined in this case not only by the position and orientation of basic reference system 4, but by additional degrees of freedom that are made possible by the pan/tilt head 5. In a first variant, the pan function is defined as an additional axis A7 and the tilt function is defined by another additional axis A8. The time sequence of changes in the A7 and A8 axes is preferably executed here synchronously with the movements of the basis reference system 4. In another variant, at least one additional camera robot 13 can be utilized. Camera robot 13 serves to capture the film sequence from a different perspective. The at least two trajectories obtained in this case can be executed synchronously with each other. To that end, camera robot 13 is coupled with the six-shaft industrial robot 8 through a synchronous control 14. This synchronization preferably refers to a time-synchronization of different trajectory models of the six-shaft industrial robot 8 and the camera robot 13. Alternatively, the six-shaft industrial robot 8 and the camera robot 13 can also be operated in such a way that they execute synchronous trajectory models with offset positions.

FIG. 2 shows a schematic depiction of a control system according to the invention. The method according to the invention can be realized in the controller 9. Controller 9 is preferably located on a control computer, which preferably has a touch screen interface attached. The touch screen 14 enables execution commands to be input into the controller manually. The trajectories 2 can be traversed for example by means of a manual control system 15. The control system 15 can be in the form of a joystick panel. A selected camera can be moved manually in space by means of the joystick. Instead of a joystick, a 6-D mouse can also be used. As an alternative to manual actuation of the cameras 3, the trajectories 2 can also be fed to the controller 9 in a simulation system 16 of a virtual set of the studio 1. A large number of pre-programmed trajectory models can be stored in controller 9. The desired trajectory model is selected by means of a control device 17. In addition, external trajectory models can be fed to controller 9 through a preferably digital input and output interface 18. Pre-programmed trajectory models can be stored in a memory 19 that is detachable from controller 9. Different memories 19 can be fed selectively to controller 9. To that end, either a single slot 20 can be provided on controller 9, into which the selected memory 19 is inserted and the corresponding trajectory model of controller 9 is thereby implemented, or else several slots 20 for a plurality of memories 19 are provided, so that a group of trajectory models can be present in the controller and the desired trajectory is selected by making a corresponding selection on control device 17. Corresponding to the selected trajectory model, the servo-amplifiers 12 are actuated through a multi-axis controller 21 and the associated shaft drives 11 are moved. In the exemplary embodiment depicted in FIG. 2 the robot shafts A1, A2, A3, A4, A5 and A6 of the six-shaft industrial robot 8 are actuated. Axis A7 is used to set the panning and axis A8 to set the tilting of camera 3. In addition, by way of example, two other axes A9 and A10 are depicted, which can be used optionally for additional camera functions such as roll, camera on/off, zoom, focus and/or iris.

FIG. 3 shows a six-shaft industrial robot according to the invention, constructed as an articulated-arm robot. A carousel 22 is rotatably connected to a base frame 23 by way of shaft A1. A motion link 24 is flexibly connected to carousel 22 by way of the shaft A2. An arm 25 is rotatably supported on an end located opposite the carousel 22 by way of the shaft A3. A central hand 26 is rotatable around its longitudinal extension by way of the shaft A4. The central hand 26 has another shaft A5, on which the receiving flange 7 is rotatably supported. Receiving flange 7 itself can execute an additional rotation around the axis 6. Pan/tilt head 5 is attached to receiving flange 7.

Pan/tilt head 5 has a connecting plate 27, which is rigidly connected to receiving flange 7. The basic reference system 4 is tied to connecting plate 27. A pivoting structure 28 is rotatably supported on connecting plate 27 by way of the axis A7. The pivoting structure 28 carries a camera holder 29, to which the camera 3 is attached. The camera holder 29 can be tilted by means of the shaft A8 relative to the pivoting structure 28.

FIG. 4 shows the six-shaft industrial robot 8 from FIG. 3, with the base frame 23 in contrast to FIG. 3 not mounted solidly on a substrate but disposed on a linear axis 30. By mounting the six-axis industrial robot 8 on a linear axis 30 an additional degree of freedom is created, which enables traveling of the complete camera/robot system. Linear axis 30 can be regarded as an additional axis A9, which can be included in the management by controller 9 in the same way as other supplemental functions.

As an alternative to a rigid mounting or to the disposition on a linear axis 30, the six-axis industrial robot 8 can also be mounted on a manually or automatically movable traveling stand, as depicted schematically in FIG. 5. In the simplest design, the traveling stand can be a manually movable carriage that has steerable wheels. Alternatively, known driverless transport systems can be used that have wheels which are drivable by means of an automatic travel controller. In all cases the travel controller can be connected through a synchronous controller 14 to the six-shaft industrial robot 8 and the pan/tilt head 5 of the camera 3, so that the shafts A1 through A6 of the six-shaft industrial robot 8 can be moved synchronously with the axes A7 and A8 of the pan/tilt head 5 of the camera 3 and the wheel drives of the platform 32. In the design shown in FIG. 5, the six-shaft industrial robot 8 is disposed on a movable platform 32, which is propelled by means of wheel drives in the form of omnidirectional wheels 33.

1. Method for moving a camera (3) disposed on a pan/tilt head (5) along a defined trajectory (2), in particular on a set or in a studio (1),
characterized in that
an associated trajectory for the spatial positions and orientations of a basic reference system (4) of the pan/tilt head (5) is determined from the defined trajectory (2) for the camera (3), and associated control variables for shafts (A1-A6) of a robot (8) movable in Cartesian coordinates, on whose receiving flange (7) the pan/tilt head (5) is attached, are generated from the determined trajectory of the basic reference system (4) of the pan/tilt head (5) and are transmitted to the shafts (A1-A6).

2. Method according to claim 1,
characterized in that an articulated-arm robot is employed as the robot (8).

3. Method according to claim 1 or 2,
characterized in that the trajectory (2) for the camera (3) or for the basic reference system (4) of the pan/tilt head (5) is traversable in real time by a manual control system (15).

4. Method according to one of claims 1 through 3,
characterized in that the trajectory (2) for the camera (3) or for the basic reference system (4) of the pan-tilt head (5) is fed from a simulation system (16) of a virtual set or studio (1) to a controller (9) of the robot (8).

5. Method according to one of claims 1 through 4,
characterized in that the trajectory (2) for the camera (3) or for the basic reference system (4) of the pan-tilt head (5) is stored in a controller (9) of the robot (8) as a pre-programmed trajectory model (19).

6. Method according to claim 5,
characterized in that a large number of pre-programmed trajectory models are stored in the controller (9), and that a trajectory model that is to be executed is activatable by being selected on a control device (17) that is coupled with the controller (9).

7. Method according to claim 5,
characterized in that the pre-programmed trajectory models are stored in a memory (19) that is detachable from the controller (9).

8. Method according to one of claims 1 through 7,
characterized in that the control variables for shafts (A1-A6) of a first robot (8) are synchronized with control variables of at least one second robot (13) by means of a synchronous control (14).

9. Method according to one of claims 1 through 8,
characterized in that the control variables for shafts (A1-A6) of the at least one robot (8, 13) and for shafts (A7, A8) of the pan-tilt head (5) of the camera (3) are synchronized by means of a synchronous control (14) with control variables for traveling drives (31) of a movable platform (32) on which the robot (8, 13) is mounted.

10. Method according to claim 9,
characterized in that the movable platform (32) is an automatically movable traveling stand or a platform with omnidirectional drives (33).

11. Method according to claim 10,
characterized in that the omnidirectional drives (33) preferably have Mecanum wheels.

12. Method according to one of claims 9 through 11,
characterized in that the position of the movable platform (32) in the plane of travel is calibrated by means of markers with known positions.

13. Method according to claim 12,
characterized in that one or more optical targets (33) affixed in the plane of travel of the movable platform (32) and/or systems that enable orientation with the aid of laser scanners or a GPS are used as markers.

14. Method according to one of claims 9 through 13,
characterized in that the position and/or orientation of the camera (3) in space is determined based in part on the position of a movable platform or a stand.

15. Method according to one of claims 1 through 14,
characterized in that the shafts (A1-A6) of the robot (8) are provided with different drive types and or transmission types, depending on different usage profiles.

16. Method according to claim 15,
characterized in that in the case of a usage profile for camera movements at low speeds and with very little noise electric motors are employed, in particular servo motors.

17. Method according to claim 16,
characterized in that the servo motors are driven by frequency converters at a frequency of over 15 kilohertz.

18. Method according to claims 15 through 17,
characterized in that in the case of a usage profile for camera movements at low speeds and with very little noise preferably harmonic drive transmissions are employed.

19. Camera robot having a pan/tilt head (4) designed to carry a camera (3), which is disposed on a receiving flange (7) of a robot (8),
characterized in that the robot (8) has at least four axes of rotation (A1-A4).

20. Camera robot according to claim 19,
characterized in that the robot (8) has six axes of rotation (A1-A6).

21. Camera robot according to claim 19 or 20,
characterized in that the camera robot (8) is connected to a controller (9) that is designed for controlling additional positioning drives for at least the pan and tilt functions of the pan/tilt head (5).

22. Camera robot according to claim 21,
characterized in that the controller (9) is additionally designed to actuate positioning drives for roll, camera, zoom, focus and/or iris.

23. Camera robot according to one of claims 19 through 22,
characterized in that the camera robot (8) is disposed on a linear drive (30) that is actuatable by the controller (9).

24. Camera robot according to one of claims 19 through 23,
characterized in that the camera robot (8) is disposed on a movable platform (32).

25. Camera robot according to claim 24,
characterized in that the movable platform (32) is an automatically or manually movable traveling stand or a platform with omnidirectional drive (33).

26. Camera robot according to claim 25,
characterized in that the omnidirectional drive preferably has Mecanum wheels.
